(19) United States
(12) Patent Application Publication
(10) Pub. No.: US 2008/0071711 A1
(43) Pub. Date: Mar. 20, 2008

(54) Method and System for Object Detection Using Probabilistic Boosting Cascade Tree

(75) Inventors: Wei Zhang, Plainsboro, NJ (US); Adrian Barbu, Tallahassee, FL (US); Yefeng Zheng, Plainsboro, NJ (US); Dorin Comaniciu, Princeton Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., Princeton, NJ (US)

(21) Appl. No.: 11/856,109

(22) Filed: Sep. 17, 2007

Related U.S. Application Data
(60) Provisional application No. 60/826,246, filed on Sep. 20, 2006.

(51) Int. Cl. G06F 15/18

(52) U.S. Cl. 706/20

(57) ABSTRACT

A method and system for object detection using a probabilistic boosting cascade tree (PBCT) is disclosed. A PBCT is a machine learning based classifier having a structure that is driven by training data and determined during the training process without user input. In a PBCT training method, for each node in the PBCT, a classifier is trained for the node based on training data received at the node. The performance of the classifier trained for the node is then evaluated based on the training data. Based on the performance of the classifier, the node is set to either a cascade node or a tree node. If the performance indicates that the data is relatively easy to classify, the node can be set as a cascade node. If the performance indicates that the data is relatively difficult to classify, the node can be set as a tree node. The trained PBCT can then be used to detect objects or classify data. For example, a trained PBCT can be used to detect lymph nodes in CT volume data.

This application claims the benefit of U.S. Provisional Application No. 60/826,246, filed Sep. 20, 2006, the disclosure of which is herein incorporated by reference.

### BACKGROUND OF THE INVENTION

The present invention relates to object detection using a probabilistic boosting cascade tree, and more particularly, to a probabilistic boosting cascade tree for lymph node detection in 3D CT volumes.

Humans have approximately 500-600 lymph nodes, which are important components of the lymphatic system. Lymph nodes act as filters to collect and destroy cancer cells, bacteria, and viruses. Under normal conditions, lymph nodes range in size from a few millimeters to about 1-2 cm. However, when the body is fighting infection, the lymph nodes may become significantly enlarged. Studies have shown that lymph nodes may have a strong relationship with detection of cancer in patients. In order to examine lymph nodes, doctors typically look for swollen lymph nodes near the body surface at locations such as the underarms, groin, neck, chest, and abdomen, where clusters of lymph nodes can be found. However, it is not easy to exam lymph nodes inside the body that are farther from the surface. Accordingly, it is desirable to detect lymph nodes in computed tomography (CT) volumes, or other medical imaging data.

FIG. 1 is a histogram illustrating lymph node sizes in a typical CT volume. The size of the lymph nodes in FIG. 1 is measured in voxels, and the resolution of each voxel is 0.7 mm. As illustrated in FIG. 1, the size of the lymph nodes in a CT volume may vary significantly. Small lymph nodes can be approximated as a sphere well, but large lymph nodes may have complicated shapes that are difficult to approximate. Due to the large variation in the size and shape of lymph nodes, automatic lymph node detection is a challenging problem.

One possible method of automatic lymph node detection is using a machine learning based classifier to determine whether each voxel in a CT volume is part of a lymph node. AdaBoost is a well-known boosting technique is computer vision and machine learning, which has been shown to approach the posterior probability by selecting and combining a set of weak classifiers into a strong classifier. The cascade approach is a well-known structure for the application of AdaBoost to object detection. This approach is described in detail in P. Viola et al., “Rapid Object detection Using a Boosted Cascade of Simple Features,” In Proc. IEEE Conf Computer Vision and Pattern Recognition, pages 511-518, 2001, which is incorporated herein by reference. A cascade is a series of classifiers, each of which classifies each data element (voxel) as either a positive or a negative. All data classified as positive advances to be classified by the next classifier, and all data classified as negative is rejected with no further processing. FIG. 2 illustrates an exemplary cascade. As illustrated in FIG. 2, the cascade contains cascade nodes 202, 204, and 206. Each of the cascade nodes 202, 204, and 206 are trained with classifiers to classify data as positive or negative. A data set is input to cascade node 202, which classifies each data element as either positive or negative. The negative data elements are rejected, and the positive data elements are processed by cascade node 204. Similarly, data elements classified as negative by cascade node 204 are rejected and data elements classified as positive by cascade node 204 are processed by cascade node 206. In typical cascades, a classifier is trained at each cascade node with a threshold selected to achieve a perfect or near perfect detection rate for positive samples. Most negative samples can be screened out in the first several cascades. However, achieving a near perfect detection rate for positives may cause a large false positive rate, especially when positive and negatives are hard to separate.

U.S. patent application Ser. No. 11/366,722, which is incorporated herein by reference, proposed a tree structure, probabilistic boosting tree (PBT), to address the problems with cascades. PBT is similar to well-known decision tree algorithms. One difference is that each tree node in a PBT is a strong decision maker, as apposed to traditional decision trees, where each node is a weak decision maker, and thus, the results at each node are more random. Since each node in a PBT is a strong decision make, PBTs can be much more compact than traditional decision trees. Another difference between PBTs and traditional decision trees is the method that an unknown sample is classified. In a traditional decision tree, a sample goes from the tree root to a leaf node. The path is determined by the classification result at each node, and the number of classifications is the level of the tree. However, in a PBT, the classification is probability based. In theory, an unknown sample is classified by all nodes in the tree, and the probabilities given by all of the nodes are combined to get the final estimate of the classification probability.

Although a PBT is more powerful than a cascade for difficult classification problems, a PBT is more likely to over-fit the training data. Another problem with PBT is that it is more time consuming than a cascade for both training and detection. The number of nodes of a PBT is an exponential function of the tree levels. For example, if a tree has n levels, the number of nodes for a full tree is 2⁰+2¹+ . . . +2ⁿ⁻¹=2ⁿ−1. However, the number of nodes for a cascade with n levels is n. With more nodes to train, a PBT consumes much more training time compared to a cascade. To calculate the posterior probability for a given sample, the sample should be processed through the while PBT. Accordingly, the sample must be classified using the trained classifier of each node in the PBT. The classification of cascades is not probability based, so most negative samples can be screened out in the first several cascades. Although there are some heuristic methods that can be used in PBT to reduce the number of probability evaluations, object detection is still more time consuming using a PBT than a cascade.

### BRIEF SUMMARY OF THE INVENTION

The present invention provides a method and system for object detection using a probabilistic boosting cascade tree (PBCT). A PBCT is a machine learning based classifier, which is more powerful in learning than a cascade and less likely to over-fit training data than a probabilistic boosting tree (PBT). A PBCT can include a plurality of nodes, some of which act as cascade nodes and some of which act as tree nodes. The structure of a PBCT is driven by training data and determined during the training process without user input.

In one embodiment of the present invention, during training of a PBCT, for each node in the PBCT, a classifier is trained for the node based on training data received at the node. The performance of the classifier trained for the node is then evaluated based on the training data. Based on the performance of the classifier, the node is set to either a cascade node or a tree node. If the performance indicates that the data is relatively easy to classify, the node can be set as a cascade node. If the performance indicates that the data is relatively difficult to classify, the node can be set as a tree node. A cascade node has one child node for further classifying positively classified data. A tree node has two child nodes, one for further classifying positively classified data and one for further classifying negatively classified data.

The training of a PBCT can lead to a structure having a plurality of cascade nodes and a plurality of tree nodes. Each of the cascade nodes and the tree nodes has a classifier that classifies the data as positive or negative. It is possible that at least one of the cascade nodes is a child node to one of the tree nodes.

In another embodiment of the present invention, an object can be detected in a CT volume by inputting the CT volume into a trained PBCT. The CT volume is processed by the PBCT to classify each voxel of the CT volume as positive (part of the object) or negative (not part of the object). A PBCT can be used as such to detect lymph nodes in a CT volume.

These and other advantages of the invention will be apparent to those of ordinary skill in the art by reference to the following detailed description and the accompanying drawings.

### BRIEF DESCRIPTION OF THE DRAWINGS

FIG. 1 is a histogram illustrating lymph node sizes in a typical CT volume;

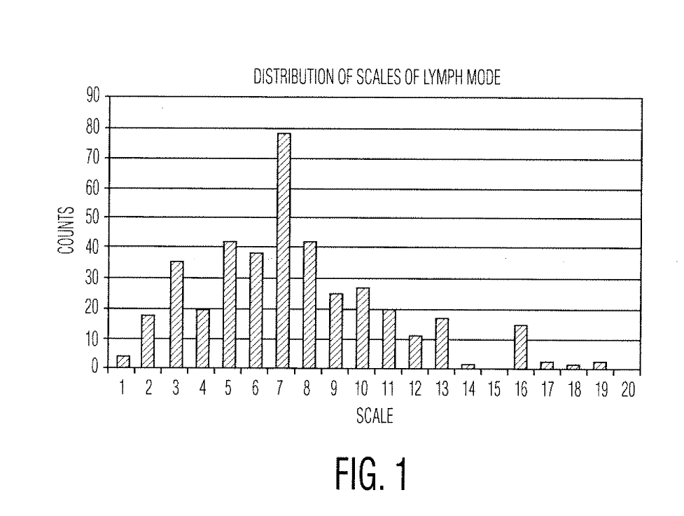

FIG. 2 illustrates an exemplary cascade;

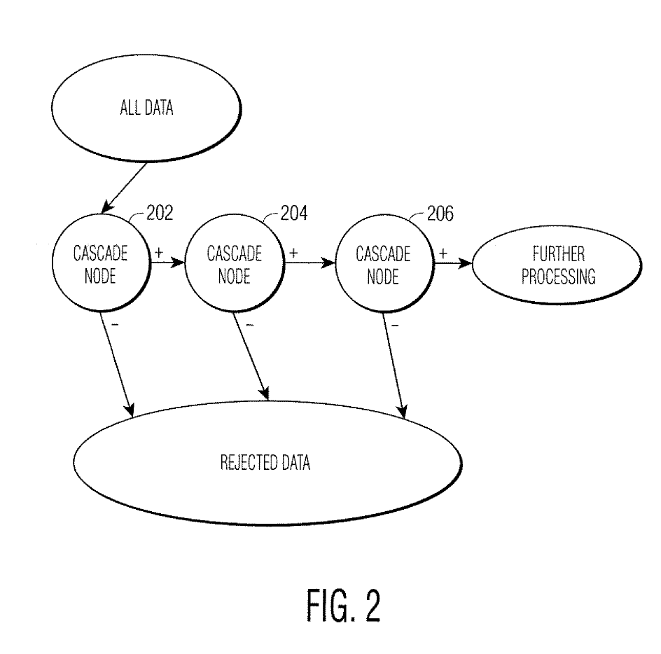

FIG. 3 illustrates a conceptual view of training and testing a probabilistic boosting cascade tree (PBCT) according to an embodiment of the present invention;

FIG. 4 illustrates a method of training a PBCT according to an embodiment of the present invention;

FIG. 5 illustrates exemplary annotated training data;

FIG. 6 illustrates an exemplary PBCT structure according to an embodiment of the present invention;

FIG. 7 illustrates a lymph node detection method using a trained PBCT according to an embodiment of the present invention;

FIG. 8 is a histogram illustrating an intensity distribution of lymph nodes in the training data;

FIG. 9 illustrates exemplary lymph node detection results according to an embodiment of the present invention; and

FIG. 10 is a high level block diagram of a computer capable of implementing the present invention.

### DETAILED DESCRIPTION

The present invention is directed to a method for object detection in images using a probabilistic boosting cascade tree (PBCT). Embodiments of the present invention are described herein to give a visual understanding of the motion layer extraction method. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

An embodiment of the present invention in which a PBCT is trained and used to detect lymph nodes in a CT volume is described herein. It is to be understood that the present invention is not limited to this embodiment and may be used for detection of various objects and structures in various types of image data. The present invention can also be applied to any other type of data classification problem.

As described above, cascades and probabilistic boosting trees have various advantages and disadvantages. Accordingly, it is desirable to utilize the advantages of both structures. For example, it is possible to put a number of cascades before a PBT structure in order to filter out a percentage of the negative samples before processing data using the PBT to learn a more powerful classifier for the samples remaining after the cascades. However, this approach requires that the number of cascades be manually tuned or selected by a user. If the classification problem is easy, more cascades should be used, and if the classification problem is difficult, cascades before the PBT may be useless. Thus, the number of cascades has to be tuned by a user by trial and error. Furthermore, this approach does not allow for cascades inside of the PBT. At a node inside, a learned classifier may be quite effective. In this case, it is not necessary to split the samples into two child nodes and train both nodes, as is required by a tree node in a PBT. Accordingly, embodiments the present invention provide an adaptive way to take advantages of both the tree and cascade structures in a PBCT. The structure of a PBCT includes both cascade nodes and tree nodes and is adaptively tuned on-line based on the training data without any user manipulation or input. Thus, within a PBCT, nodes which perform effective classification can be treated as cascade nodes and discard negatively classified data, while nodes which are less effective are treated as tree nodes, and split the data into two child nodes to be further classified.

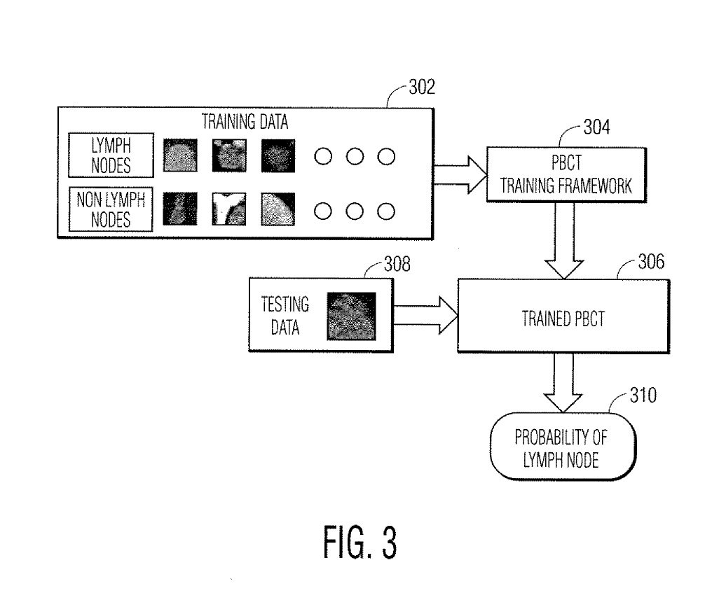

FIG. 3 illustrates a conceptual view of training and testing a PBCT according to an embodiment of the present invention. As illustrated in FIG. 3, training data 302 is input to a PBCT training framework 304. The training data 302 includes data that is annotated as positive samples and negative samples. For example, the positive samples in the training data 302 includes voxels from CT volume data which are annotated as lymph nodes, and the negative samples include voxels which are not lymph nodes. The PBCT training framework 304 implements a training method to train a PBCT classifier based on the training data 302 resulting in a trained PBCT 306. The PBCT training framework 304 can be implemented as computer program instructions stored on a computer readable medium. The trained PBCT can also be stored on a computer readable medium. Testing data 308 can then be input to the trained PBCT 306 in order to use the trained PBCT 306 to detect lymph nodes in the testing data 308. The testing data 308 can be a CT volume for an individual patient. The trained PBCT 306 processes the testing data 306 through a plurality of nodes, each of which performs a classification operation on the testing data, in order to determine a probability 310 for each voxel in the testing data 308 that the voxel is a lymph node.

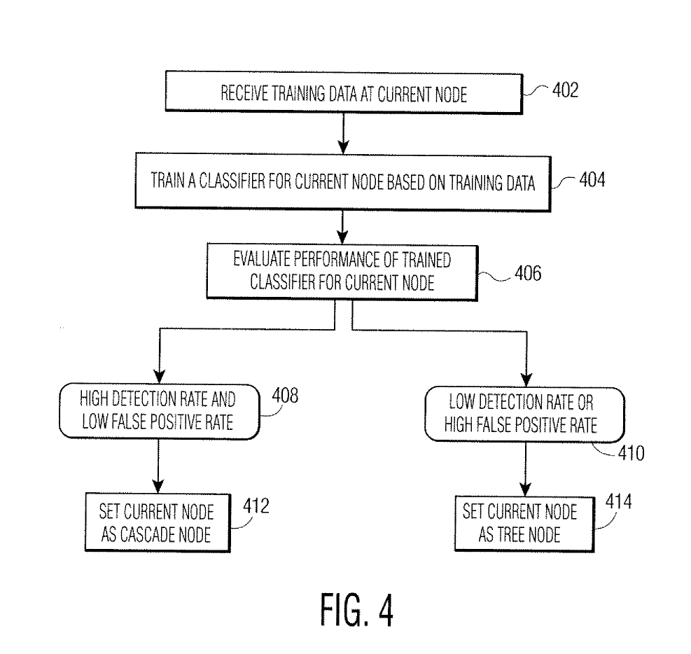

FIG. 4 illustrates a method of training a PBCT according to an embodiment of the present invention. The method of FIG. 4 can be performed by the training framework 304 of FIG. 3 in order to train the PBCT for lymph node detection. The steps in the method of FIG. 4 illustrate the procedure for training a node in the PBCT, and are repeated for each node of the PBCT. The structure of the PBCT is determined as the PBCT trained, such that when each node is trained it determined how many child nodes must be trained for that node.

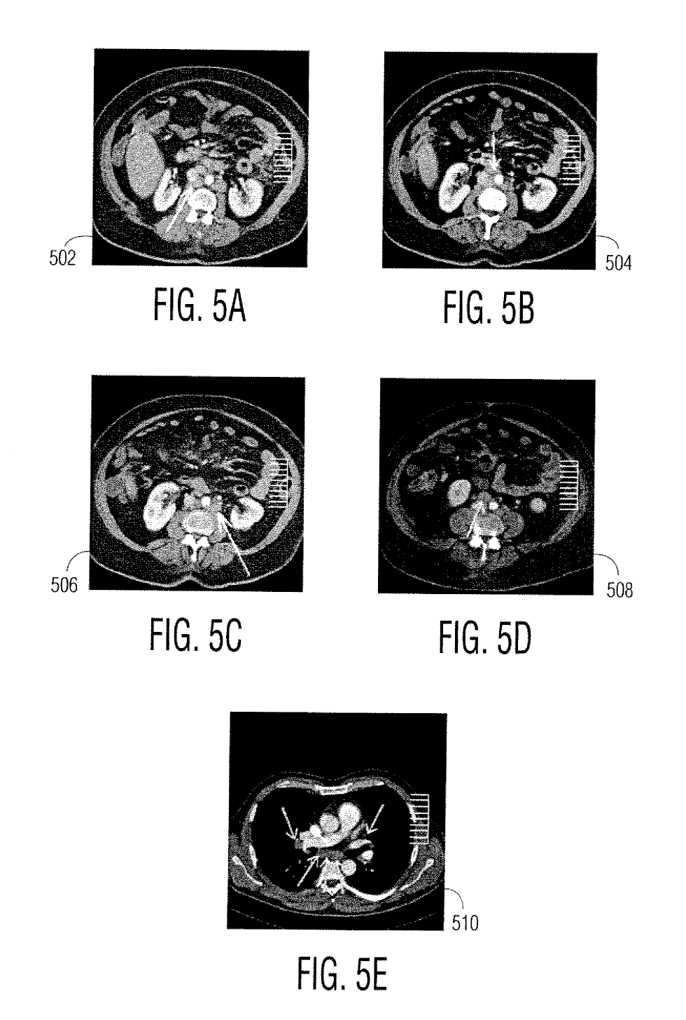

At step 402, training data is received at a current node. The training data can be annotated to show positive and negative sample. FIG. 5 illustrates exemplary annotated training data. As illustrated in FIG. 5, images 502, 504, 506, 508, and 510 are 2D slices taken from 3D CT volume data sets and annotated by a doctor in order to identify lymph nodes in the 2D slices. It is possible to convert each 2D annotation to 3D coordinates based on the location of each slice within the original 3D CT volume. The voxels identified based on these coordinates are positive samples in the training data. Negative samples can be randomly selected from voxels which are unlikely to be lymph nodes. For example, it is possible to select voxels for negative samples that are more than 15 voxels away (in Euclidean distance) annotated lymph node centers. A various nodes in the PBCT are trained the training data will be divided and some will be discarded. Accordingly, different portions of the training data will be received at each node.

Returning to FIG. 4, at step 404, a classifier is trained for the current node based on the training data received at the current node. The classifier trained at the node is a strong classifier. A strong classifier is a combination of a number of weak classifiers and has greater classification power then weak classifiers. A weak classifier is a simple classifier which classifies a voxel based on a particular feature. Weak classifies can classify a voxel as positive or negative, although the classification power is weak and the classification accuracy is low. For the task of lymph node detection, a weak classifier is based on the response of a particular feature. A threshold is chosen automatically during training. When the feature response of a voxel is greater than the threshold, the voxel will be classified as a positive, thus forming a weak classifier. A strong classifier can be trained based on a large number of features by combining a set of weak classifiers. Adaboost includes a well-known algorithm for training a strong classifier based on a set of weak classifiers. This algorithm is described in detail in P. Viola et al., “Rapid Object detection Using a Boosted Cascade of Simple Features,” In Proc. IEEE Conf Computer Vision and Pattern Recognition, pages 511-518, 2001, which is incorporated herein by reference. The classifier trained for a node classifies each voxel of the training data received at the node as positive or negative.

At step 406, the performance of the classifier trained for the current node is evaluated based on the training data. Accordingly, the training data is used to test the classifier trained for the current node in order to calculate a detection rate and a false positive rate. The detection rate is a measure of a percentage of positive samples in the training data that were classified as positive, and the false positive rate is a measure of a percentage of negative samples in the training data that were classified as positive. If the data for that node is relatively easy to classify, the classifier will have a high detection rate and a low false positive rate. If the data is relatively difficult to classify, the classifier will have a low detection rate and a high false positive rate. Accordingly, in order to evaluate the performance of the trained classifier, the detection rate can be compared to a first threshold, and the false positive rate can be compared to a second threshold.

The training method performs alternate steps depending on the evaluated performance of the trained classifier. If the trained classifier has a high detection rate and a low false positive rate (408), the method proceeds to step 412. For example, if the detection rate is greater than or equal to the first threshold and the false positive rate is less than or equal to the second threshold, the method can proceed to step 412. If the trained classifier has a low detection rate or a high false positive rate (410), the method can proceed to step 414. For example, if the detection rate is less than the first threshold and the false positive rate is greater than the second threshold, the method can proceed to step 414. According to an advantageous embodiment of the present invention, the first threshold can be 97% and the second threshold can be 50%, but the present invention is not limited thereto.

At step 412, the current node is set as a cascade node. Accordingly, the current node will have one child node in the next level of the tree and only the training data classified as positive by the current node will be used to train the child node. The training data classified as negative by the current node is discarded with no further processing or classification.

At step 414, the current node is set as a tree node. Accordingly, the current node will have two child nodes in the next level of the tree. One of the child nodes will be trained using the training data classified as positive by the current node, and one of the child nodes will be trained using the training data classified as negative by the current node. Accordingly, the structure for a next level of the tree is not known until the prior level is trained. Thus, the structure of the PBCT is automatically constructed level by level during the training of the PBCT.

For each node in the PBCT, the training method determines whether the number of training samples for the node is less than a certain threshold. If the number of training samples is less than the threshold, the node will not be further expanded such that no child nodes are generated for that node. Accordingly, the structure of the PBCT is determined such that each branch of the PBCT ends in a terminal node at which there is a relatively small number of training samples.

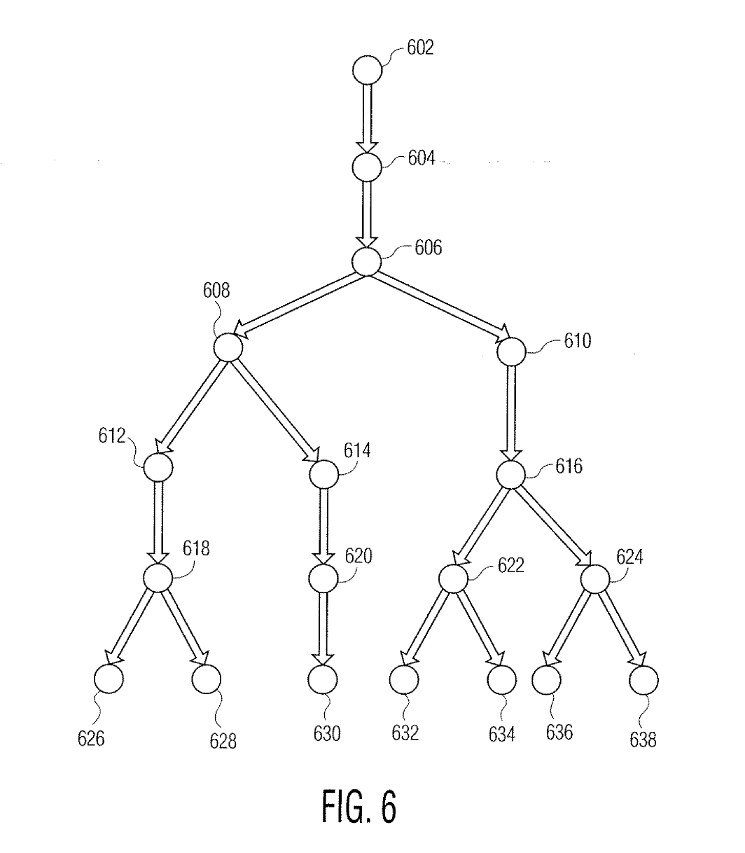

FIG. 6 illustrates an exemplary PBCT structure according to an embodiment of the present invention. As illustrated in FIG. 6, the PBCT includes a plurality of nodes 602-638, each having a trained classifier which classifies data received at the node into positive and negative. The PBCT includes cascade nodes 602, 604, 610, 612, 614, and 620, as well as tree nodes 606, 608, 616, 618, 622, and 624. The cascade nodes 602, 604, 610, 612, 614, and 620 each have one child node For example, node 618 is the child node of node 612. Each of the tree nodes 606, 608, 616, 618, 622, and 624 has two child nodes. For example, nodes 612 and 614 are the child nodes of node 608. As shown in FIG. 6, it is possible for a cascade node to be a child node of a tree node (e.g., 610, 612, and 614), and it is also possible for a tree node to be a child node of a cascade node (e.g., 606, 6161, and 618). The child node of a cascade node further classifies the data classified positively by the cascaded node, while the data classified negatively is discarded. A tree node classifies data into two subsets, each of which are further classified by one of the child nodes of the tree node. As described above, the structure of such a PBCT is determined based on the training data during the training method, without user input.

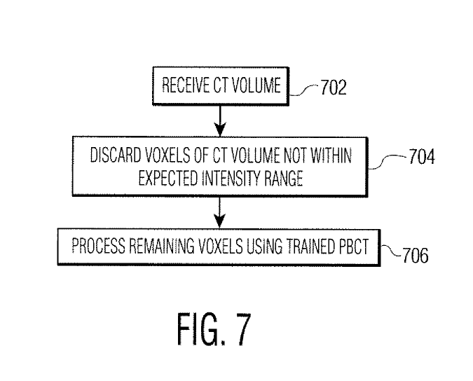

FIG. 7 illustrates a lymph node detection method using a trained PBCT according to an embodiment of the present invention. As illustrated in FIG. 7, at step 702, a CT volume is received. The CT volume can be previously stored on a computer system or received from a CT scanning device, or the like.

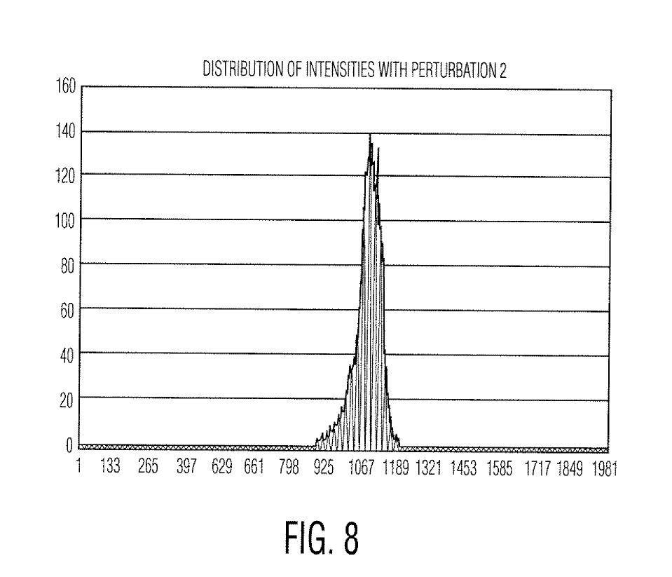

At step 704, voxel of the CT volume that are not within an expected intensity range of the lymph nodes are discarded. The voxel intensities in CT volumes range from 0 to about 2400. The intensity values of lymph nodes tend to fall within a more specific range. FIG. 8 is a histogram illustrating the intensity distribution of lymph nodes in the training data. As illustrated in FIG. 8, the intensity values of lymph nodes can be expected to be within the range of approximately 900 to 1200. Accordingly, voxels having an intensity less than 900 or greater than 1200 are unlikely to be lymph nodes and can be discarded. It is possible that this will eliminate more than 75% of the original voxels in the CT volume. Thus, this step can accelerate the detection of lymph nodes and decrease the false positive rate for the detected lymph nodes.

At step 706, the remaining voxels of the CT volume are processed using a trained PBCT. As described above, the PBCT is trained based on training data including annotated lymph node voxels. The PBCT can include cascade nodes and tree nodes. Each node in the PBCT classifies all of the voxels received at the node as positive or negative. If a node is a cascade node the positively classified voxels are further classified at a child node, and the negatively classified voxels are discarded. If a node is a tree node, one child node further classifies positively classified voxels and another child node further classifies negatively classified voxels. Accordingly, the voxels of the CT volume are processed through all of the nodes of the trained PBCT such that a probability of being a lymph node can be determined for each voxel (discarded voxels have a probability of 0).

The voxels positively detected as lymph nodes by the PBCT are clustered. This suggests that it is possible to predict the probability of a voxel being a lymph node based on neighboring voxels. Accordingly, the PBCT can be used along with probability prediction to determine a probability of a voxel being a lymph node. First, the trained PBCT based detector can be used to scan across a CT volume with the pace along each axis set to be 2 so that every other voxel along each axis is scanned to determine the probability of being a lymph node. Therefore, the detector will run on ⅛ of the volume voxels in this stage. Then the probabilities of the rest of the voxels can be predicted using tri-linear interpolation. If the predicted probability of a voxel is not large enough, it will be skipped without further processing. The predicted probability can be quite close to the probability calculated using the PBCT. Based on experiments to check the prediction error, the average error is μₑ=0.082 with the standard deviation σₑ0.014. Therefore, only if a voxel's predicted probability Pₑ satisfies pₑ>Tₚ−0.122 (μₑ+σₑ*3=0.122), where Tₚ is the detection threshold, the probability for the voxel would be calculated using the trained PBCT. Otherwise, the voxel is discards, because the probability that it is calculated probability is greater than Tₚ is less than 0.03, i.e., P{pₑ>T_{p}<}0.03, assuming that P{Pₑ} obeys a Gaussian distribution. In this manner, it is possible to use the PBCT along with interpolation based probability prediction to reduce detection time and reduce the false positive rate.

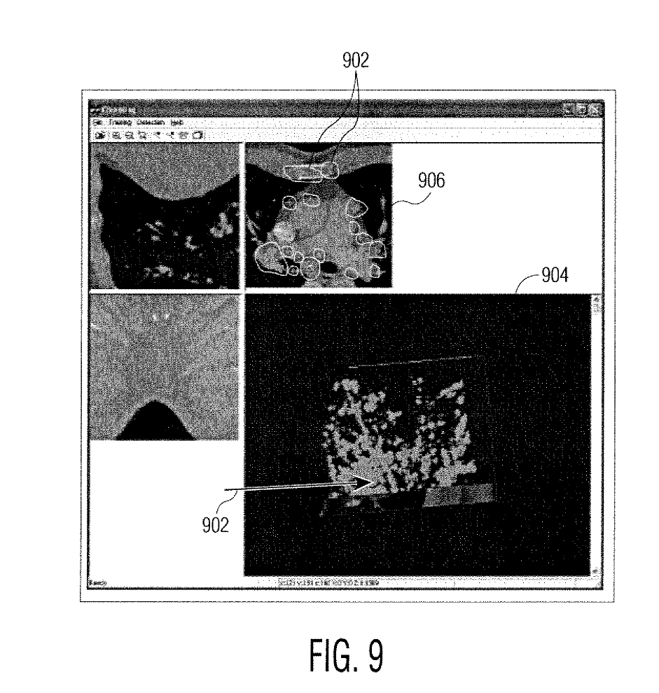

FIG. 9 illustrates exemplary lymph node detection results using a trained PBCT according to an embodiment of the present invention. As illustrated in FIG. 9, detected positives 902 are shown in a 3D CT sub-volume 904 and a 2D CT slice 906.

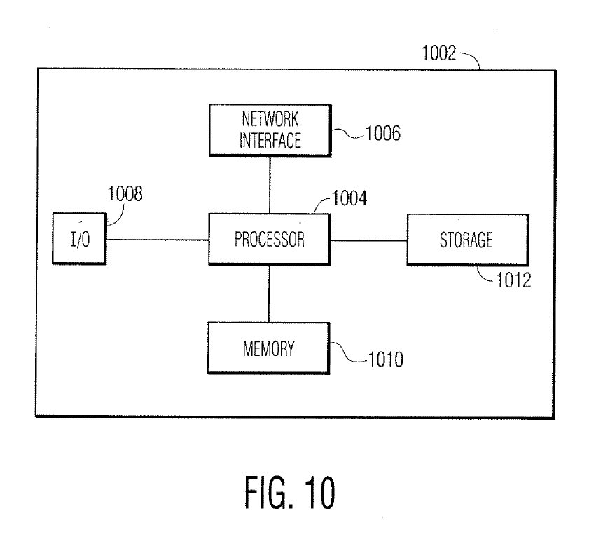

The above-described methods for training a PBCT and object detection using a PBCT may be implemented on a computer using well-known computer processors, memory units, storage devices, computer software, and other components. A high level block diagram of such a computer is illustrated in FIG. 10. Computer 1002 contains a processor 1004 which controls the overall operation of the computer 1002 by executing computer program instructions which define such operation. The computer program instructions may be stored in a storage device 1012 (e.g., magnetic disk) and loaded into memory 1010 when execution of the computer program instructions is desired. Thus, applications for training a PBCT and processing data through the nodes of a trained PBCT may be defined by the computer program instructions stored in the memory 1010 and/or storage 1012 and controlled by the processor 1004 executing the computer program instructions. Furthermore, training data, testing data, the trained PBCT, and data resulting from object detection using the trained PBCT can be stored in the storage 1012 and/or the memory 1010. The computer 1002 also includes one or more network interfaces 1006 for communicating with other devices via a network. The computer 1002 also includes other input/output devices 1008 that enable user interaction with the computer 1002 (e.g., display, keyboard, mouse, speakers, buttons, etc.) One skilled in the art will recognize that an implementation of an actual computer could contain other components as well, and that FIG. 10 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for training a probabilistic boosting cascade tree having a plurality of nodes, comprising:
(a) receiving training data at a node;
(b) training a classifier for the node based on said training data;
(c) evaluating a performance of the classifier for the node based on the training data;
(d) setting the node as one of a cascade node and a tree node based the performance of the classifier for the node.

2. The method of claim 1, wherein step (b) comprises:
training a strong classifier for the node based on said training data.

3. The method of claim 1, wherein step (c) comprises:
calculating a detection rate and a false positive rate of the classifier for the node based on the training data.

4. The method of claim 3, wherein step (d) comprises:
if the detection rate is greater than or equal to a first threshold and the false positive rate is less than or equal to a second threshold, setting the node as a cascade node; and
if the detection rate is less than the first threshold or the false positive rate is greater than the second threshold, setting the node as a tree node.

5. The method of claim 1, further comprising:
if the node is set as a cascade node, generating one child node for the node, said one child node for further classifying training data classified as positive by said classifier; and
if the node is set as a tree node, generating first and second child nodes for the node, said first child node for further classifying training data classified as positive by said classifier and said second child node for further classifying training data classified as negative by said classifier.

6. The method of claim 1, wherein said training data comprises CT volume data including a plurality of annotated positive samples and a plurality of annotated negative samples, wherein said positive samples are voxels in the CT volume corresponding to anatomical objects and said negative samples are voxels in the CT volume not corresponding to said anatomical objects.

7. The method of claim 6, wherein said anatomical objects are lymph nodes.

8. The method of claim 1, further comprising:
(e) repeating steps (a)-(d) for each node is said probabilistic boosting cascade tree.

9. The method of claim 8, further comprising:
processing an input CT volume through each node in said probabilistic boosting cascade tree to detect anatomical objects in said input CT volume.

10. A method for detecting objects in CT volume data using a probabilistic boosting cascade tree (PBCT), comprising:
receiving an input CT volume;
processing said input CT volume using a PBCT having a plurality of nodes to detect one or more objects in said input CT volume, wherein said PBCT comprises at least one tree node and at least one cascade node.

11. The method of claim 10, wherein said PBCT comprises at least one cascade node that is a child node to a tree node.

12. The method of claim 10, wherein said step of processing said input CT volume using a PBCT comprises:
determining for each of a plurality of voxels in said input CT volume, whether that voxel is part of said one or more objects.

13. The method of claim 10, wherein said objects are lymph nodes.

14. The method of claim 10, further comprising:
removing voxels not within a certain intensity range corresponding to said objects from said input CT volume prior to said processing step.

15. A probabilistic boosting cascade tree stored in a computer readable medium for detecting an object in a set of data, comprising:
a plurality of cascade nodes, each comprising a classifier for classifying data received at the node as positive or negative, and each having one child node for further classifying the positively classified data; and
a plurality of tree nodes, each comprising a classifier for classifying data received at the node as positive or negative, and each having a first child node for further classifying the positively classified data and a second child node for further classifying the negatively classified data.

16. The probabilistic boosting cascade tree of claim 15, wherein at least one of said plurality of cascade nodes is a child node to one of said plurality of tree nodes.

17. The probabilistic boosting cascade tree of claim 15, wherein a number of the plurality of cascade nodes and the plurality of tree nodes and relative locations of the plurality of cascade nodes and the plurality of tree nodes are determined based on training data used to train the classifiers of the cascade node and the tree nodes.

18. The probabilistic boosting cascade tree of claim 17, wherein the number of the plurality of cascade nodes and the plurality of tree nodes and the relative locations of the plurality of cascade nodes and the plurality of tree nodes are determined automatically based on the training data without user input.

19. An apparatus for training a probabilistic boosting cascade tree having a plurality of nodes, comprising:
means for receiving training data at a node;
means for training a classifier for the node based on said training data,
means for evaluating a performance of the classifier for the node based on the training data;
means for setting the node as one of a cascade node and a tree node based the performance of the classifier for the node.

20. The apparatus of claim 28, wherein said means for evaluating a performance of the classifier comprises:
means for calculating a detection rate and a false positive rate of the classifier for the node based on the training data.

21. The apparatus of claim 20, wherein said means for setting the node as one of a cascade node and a tree node comprises:
means for setting the node as a cascade node if the detection rate is greater than or equal to a first threshold and the false positive rate is less than or equal to a second threshold; and
means for setting the node as a tree node if the detection rate is less than the first threshold or the false positive rate is greater than the second threshold.

22. The apparatus of claim 19, further comprising:
means for generating one child node for the node if the node is set as a cascade node; and
means for generating first and second child nodes for the node if the node is set as a tree node.

23. The apparatus of claim 19, further comprising:
means for processing an input CT volume through each node in said probabilistic boosting cascade tree to detect anatomical objects in said input CT volume.

24. An apparatus for detecting objects in CT volume data using a probabilistic boosting cascade tree (PBCT), comprising:
means for receiving an input CT volume;
means for processing said input CT volume using a PBCT having a plurality of nodes to detect one or more objects in said input CT volume, wherein said PBCT comprises at least one tree node and at least one cascade node.

25. The apparatus of claim 24, wherein said PBCT comprises at least one cascade node that is a child node to a tree node.
